(19) United States
(12) Patent Application Publication
(10) Pub. No.: US 2003/0145896 A1
(43) Pub. Date: Aug. 7, 2003

(54) Coiled laminated air brake tubing

(75) Inventors: Edward A. Green, Mantua, OH (US); Dominic Profio, Ravenna, OH (US); William Cramer, Suffield, OH (US)

Correspondence Address: WOOD, HERRON & EVANS, LLP, 2700 CAREW TOWER, 441 VINE STREET, CINCINNATI, OH, 45202, US

(73) Assignee: Saint-Gobain Performance Plastics Corporation

(21) Appl. No.: 10/068,184

(22) Filed: Feb. 6, 2002

(51) Int. Cl. F16L 11/08

(52) U.S. Cl. 138/125; 138/137; 138/141

(57) ABSTRACT

An improved coiled air brake tubing is formed from a nylon polyurethane laminate. The laminate includes an innermost nylon layer surrounded with a thick intermediate polyurethane layer in turn covered with an outermost thin nylon layer. The polyurethane layer is fiber reinforced. The product is extruded and coiled around a heated mandril causing it to assume a coiled set. This exhibits improved low temperature properties and is less expensive than a nylon product.

### BACKGROUND

Air brake systems which are used in heavy duty vehicles such as tractor trailers and utilize pressurized air transported through tubing. Metal tubing can be employed in certain applications. However nylon tubing is generally preferred and in particular polyester reinforced nylon tubing. Nylon tubing such as disclosed in Brumbach, U.S. Pat. No. 3,062,241 has met with exceptional success and has been established as the industry standard. Generally such tubing is intended to operate at pressures up to 150 psi over a very wide operating range, for example, from −40° C. to 90° C.

In order to improve on basic nylon tubing and reduce costs, certain laminated brake tubing has been developed such as that disclosed in Green et al., U.S. Pat. No. 6,071,579. This uses an inner and outer layer of nylon and a central layer of high density polyethylene. This has certain advantages particularly in terms of expense.

In certain applications it is required that the air brake tubing be formed as a coil such as disclosed in Coe, U.S. Pat. No. 3,245,431, Ramos, U.S. Pat. No. 5,232,645 and Philllippi, U.S. Pat. No. 3,977,440. This tubing is made from a variety of different polymers such as polyethylene and nylon.

Nylon has become the industry standard in automotive applications. It exhibits excellent resistance to cracking, fuel and water. It also exhibits such characteristics over a wide range of operating temperature. Unfortunately nylon is relatively expensive and certain nylons present supply problems.

### SUMMARY OF THE INVENTION

The present invention is premised on the realization that laminated coiled air brake tubing can be formed from less expensive raw materials while improving physical properties. More particularly, the present invention is premised upon the realization that a polyurethane tubing laminated on either side with layers of nylon can be formed into coiled air brake tubing having improved cold temperature properties, greater flexibility while using lower cost materials than nylon air brake coiled products.

The present invention is a multi-layered co-extruded product with a polyurethane core covered with inner and outer layers of nylon. Preferably the polyurethane core includes a fiber reinforcing layer.

The objects and advantages of the present invention will be further appreciated in light of the following detailed description and drawings in which:

### BRIEF DESCRIPTION OF THE DRAWINGS

FIG. 1 is a perspective view partially broken away of the present invention.

FIG. 2 is a cross-section view taken at Lines 2-2 of FIG. 1.

### DETAILED DESCRIPTION

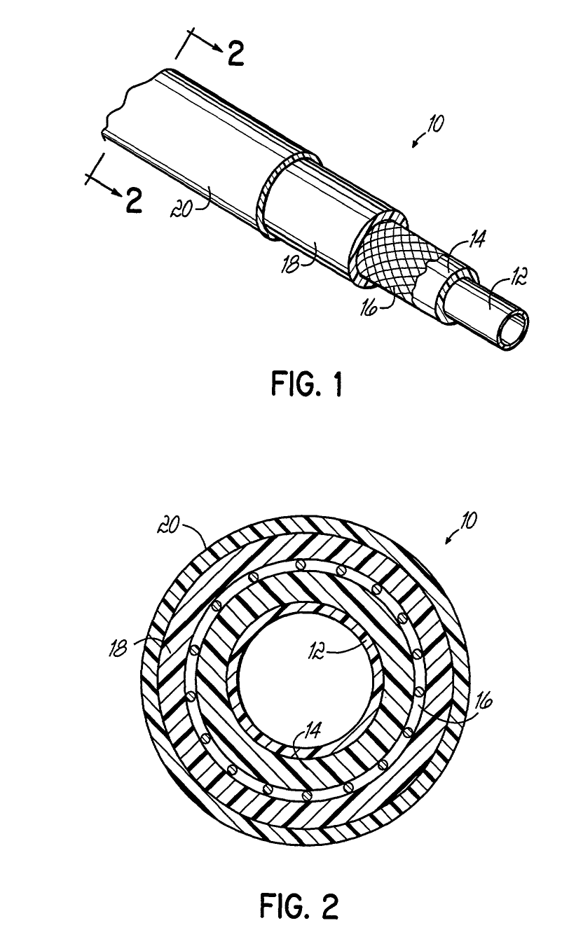

As shown in FIG. 1, the present invention is a multi-layered laminated coiled air brake tubing 10 which includes an inner most nylon layer 12 coated with a first polyurethane layer 14 which is surrounded with a fiber reinforcement 16. This is in turn coated by a second polyurethane layer 18 which is covered with an exterior nylon layer 20.

The nylon layers can be the same or different nylon material. Basically any nylon can be used. However, preferably the nylon will be nylon 6, 6-12, 12 or 11. These all exhibit excellent abrasion resistance and cold temperature properties. Nylon 12 exhibits the best cold temperature properties and therefore is preferred.

The innermost nylon layer 12 will preferably have a thickness of about 2 to 5 mills and preferably about 3 mills. It is generally preferable to establish this layer 12 as thin as possible to reduce costs as long as it adequately coats the polyurethane to provide necessary solvent and water resistance. The exterior nylon layer 20 is preferably 5 to 10 mills thick and most preferably about 7 mills thick. This provides in addition to solvent resistance, abrasion resistance.

Covering the inner nylon layer 12 is first polyurethane layer 14. Both polyurethane layers are preferably formed from the same material. The term polyurethane is intended to include polyether as well as polyester polyurethanes. A wide variety of different thermoplastic polyurethanes can be used in the present invention. The polyether polyurethane is preferred.

It is preferable that they have a durometer from about 80A-63D with about 55 preferred. If the polyurethane layer is too soft, it will tend to form a weak product. The selected polyurethane must remain flexible from about −75° F. up to about 200° F. One preferred polyurethane is produced by BASF designated 1154D. This product is a non-foam thermoplastic polyurethane having a hardness of 53+/−2. Its tensile strength is 5800 psi with a tensile stress at 100% elongation of 2900 psi and a 300% elongation 4300 psi. It melts at between 410° F. and 440° F.

The thickness of the initial polyurethane layer 16 should be from about 32 to 35 mills and preferably 34 mills. This can vary significantly depending on the intended strength of the tubing as this layer 14 in combination with a second polyurethane layer 18 provides much of the strength of the laminated tubing.

In order to reinforce the tubing, a fiber layer 16 can be embedded onto the surface of the first polyurethane layer 14. The particular reinforcing fiber or braiding is not critical as long as it is compatible with the polyurethane layer. The braiding material can be any acceptable fiber product such as a nylon fiber or polyester fiber which is preferred. One preferred polyester fiber is an 840 denier polyester. This braiding utilizes six strands of the fiber applied at about three to six pics per inch preferably 4 pics.

The fiber reinforcing layer 16 is in turn covered with the second polyurethane layer 18. Again, this can be the same or different polyurethane. It is preferably the same polyurethane as layer 14.

The thickness of the second polyurethane layer 18 is again determined by the intended strength of the product. In a preferred embodiment of the present invention, the second layer will have a thickness of 30 to 34 mills preferably about 31 mills.

As indicated, the outermost layer of nylon 20 has a thickness of about 5 to 10 mills preferably 7 mills.

Commercially available plasticized polyamines include Rilsan Aesno P40 TL 89 (nylon 11) or plasticized nylon 12 sold by Huls under the brand name X7293 or Rilsan Aesno P401 TL. Alloys of nylon 11 and 12 can also be employed. Hereinafter nylon is intended to include both 100% nylon as well as comparably performing nylon blends. These alloys can include 50% by weight of compatible polymers such as high density polyethylene.

To form the tubing 11 of the present invention. The inner nylon layer 12 is co-extruded with the first polyurethane layer 14. The melt temperature of the nylon extruder should be about 440° F. to about 460° F. preferably about450° F. The melt temperature of the polyurethane extruder should be about 420° F. to about 440° F. preferably about 430°.

Braiding is then applied over the polyurethane layer by passing the two-layer extruded tubing through a braider or fiber reinforcing apparatus. The reinforcing material may be braided, knitted, or spirally wrapped wherein one strand of the material is applied at a pitch to one direction and another strand is applied over the first with a pitch to the opposite direction. The braider is preferably a counter-rotating fiber reinforcing device or may be any suitable and known conventional braiders. Preferably the braided layer is applied with six bobbins of fiber with 3 to 6 pics per inch and preferably 4 pics per inch. One commercially available polyester fiber is sold by Hoechst Celonese under the designation 840/70/NAR.

Once the braiding is applied, the outer two layers are co-extruded over the inner tubing in the same manner as the inner two layers at the same temperatures. However prior to doing so, the surface of the polyurethane layer 14 is preferably coated with a solvent which assists the second polyurethane layer to adhere to the first polyurethane layer. Two preferred solvents include dimethyl formamide and N-methyl pyrrolidone. These are simply misted on the surface of the first polyurethane layer immediately prior to passing this through the second extruder.

Once the laminated tubing is formed, it is wrapped around a mandrel and cut to a predetermined length with two straight ends. The mandrel and tubing are heated to a temperature of about 275° F. and maintained for about twenty minutes. The tubing and mandrel are allowed to cool causing a permanent set in the tubing.

The product of the present invention was tested for flexibility, fatigue and cold temperature impact. This product was compared with a nylon tubing similar to the product disclosed in Phillippi, U.S. Pat. No. 3,977,440 and a polyethylene product similar to that disclosed in Ramos, U.S. Pat. No. 5,232,645.

### Flexibility

In the first test, tubing with 14 coils were formed. One end of each coil was attached to a fixed wall and the second end was attached to a scale. The weight required to move the tubing two feet was measured at ambient temperatures. The tubing was placed in a freezer at −40° F. for eight hours and the test was repeated at −40° F. The results are shown in the following Table I.

TABLE I

| | @ ambient temperature | Cold temperature |
|---|---|---|
| | (70° F.) | (−40° F.) |
| New product- | 1.5 lb. | 16 lb. |
| Nylon product | 2.5 lb. | 34 lb. |
| (Phillippi) | | |
| Polyethylene product | 7 lb. | 28 lb. |
| (Ramos) | | |

### Fatigue Flexing

The products were then tested for fatigue by repeatedly bending the tubing at a rate of 38 cycles per second. Each bend would kink the tubing. After 8 hours the tubing was pressured to 500 psi for one minute. The hose was then subjected to the bending again for 8 hours, and pressurized again. This was repeated until the product burst. The results of this test are shown in Table II.

TABLE II

| | U-bend kink flexing cycles to burst failure |
|---|---|
| New product- | 1,300,000 cycles no failures (test stopped) |
| Nylon product (Phillippi) | 120,000 cycles fail burst |
| Polyethylene product | 18,000 cycles fail burst |
| (Ramos) | |

As indicated, the product of the present invention withstood 1,300,000 cycles without failure and the test was finally stopped. This is in excess of ten times better than a nylon product and nearly 100 times better than the polyethylene product.

### Cold Impact

Finally, cold temperature impact was tested according to SAEJ 844 at −65° F. The test is run on ten samples of each of the three tubing products.

TABLE III
The results are shown in Table III below:

| | Cold impact @−65° F. |
|---|---|
| New product - | Pass |
| Nylon product | 100% failure (product shattered) |
| (Phillippi) | |
| Polyethylene product | Pass |
| (Ramos) | |

Both the product of the present invention and the polyethylene product withstood the cold impact test whereas the nylon product failed at this temperature.

The tubing of the present invention exhibits improved cold temperature properties, and costs less than nylon air brake coiled product. It has increased flexibility both at ambient and low temperature. Whereas the low temperature limit of nylon is about −40° F., the tubing of the present invention can withstand impacts at −65° F. The abrasion and chemical resistance of nylon is retained by utilizing the interior and exterior layers of nylon. Thus, the present invention improves performance and decreases costs.

This has been a description of the present invention along with the preferred method of practicing the invention. The invention itself should only be defined by the appended claims wherein we claim:

1. A coiled air brake tubing comprising a laminated tube said tube having an innermost layer of nylon, an intermediate layer of a polyurethane and an outermost layer of nylon wherein said tubing is set in a coiled configuration.

2. The method claimed in claim 1 wherein said polyurethane is selected from the group consisting of polyether polyurethane and polyester polyurethane.

3. The coiled tubing claimed in claim 1 further comprising a fiber reinforcing layer within said polyurethane layer.

4. The coiled tubing claimed in claim 3 wherein said fiber layer is a polyester layer.

5. The coiled tubing claimed in claim 3 wherein said fiber reinforcing layer includes three to six pics per inch.

6. The coiled tubing claimed in claim 1 wherein said innermost layer of nylon is from about 2 to about 5 mills.

7. The method claimed in claim 1 wherein said nylon layers are selected from the group consisting of nylon 6, nylon 11 and nylon 12 and alloys thereof.

8. The method claimed in claim 1 wherein said polyurethane layer is a polyether polyurethane.

9. The coiled tubing claimed in claim 8 wherein said polyurethane has a hardness of 80A-63D.

10. The method of forming a coiled laminated air brake tubing comprising co-extruding an innermost nylon layer and a first polyurethane layer;
forming a fiber reinforcing layer over said first polyurethane layer;
applying a solvent to said first polyurethane layer;
extruding a second polyurethane layer over said fiber reinforcing layer and said first polyurethane layer; and
extruding an outermost nylon layer over said second polyurethane layer.

11. The method claimed in claim 10 wherein said solvent is selected from the group consisting of N-methyl pyrrolidone and diemethyl formamide.
